(19) United States
(12) Patent Application Publication
(10) Pub. No.: US 2026/0142772 A1
(43) Pub. Date: May 21, 2026

(54) UPLINK PRECODING BASED ON USER EQUIPMENT COHERENCY

(71) Applicant: QUALCOMM Incorporated, San Diego, CA (US)

(72) Inventors: Hyojin LEE, San Diego, CA (US); Yu ZHANG, San Diego, CA (US); Jing JIANG, San Diego, CA (US); Jing SUN, San Diego, CA (US); Mostafa KHOSHNEVISAN, San Diego, CA (US)

(21) Appl. No.: 18/955,594

(22) Filed: Nov. 21, 2024

(51) Int. Cl. H04L 5/00

(52) U.S. Cl. CPC H04L 5/0048

(57) ABSTRACT

Methods, systems, and devices for wireless communications are described. A user equipment (UE) may transmit one or more sounding reference signals (SRSs) for uplink sounding. The UE may receive, based on the SRS transmission, one or more indications of a grant of uplink resources and a precoding associated with a coherency configuration between the SRS transmission and an uplink transmission. The coherency configuration may be associated with whether a relative phase coherency, a relative power coherency, or both are maintained, between the SRS transmission and the uplink transmission, for a set of one or more antenna ports at the UE. In response, the UE may transmit the uplink transmission in accordance with the indicated grant of uplink resources and the indicated precoding associated with the coherency configuration.

### FIELD OF TECHNOLOGY

The following relates to wireless communications, including uplink precoding based on user equipment coherency.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include transmitting, from the UE, one or more sounding reference signals (SRSs), receiving, at the UE based on the transmission of the one or more SRSs, one or more indications of a grant of uplink resources and a precoding associated with a coherency configuration between the transmission of the one or more SRSs and an uplink transmission, and transmitting, from the UE, the uplink transmission in accordance with the indicated grant of uplink resources and the indicated precoding associated with the coherency configuration.

A UE for wireless communications is described. The UE may include one or more memories storing processor executable code, and one or more processors coupled with the one or more memories. The one or more processors may individually or collectively be operable to execute the code to cause the UE to transmit, from the UE, one or more SRSs, receive, at the UE based on the transmission of the one or more SRSs, one or more indications of a grant of uplink resources and a precoding associated with a coherency configuration between the transmission of the one or more SRSs and an uplink transmission, and transmit, from the UE, the uplink transmission in accordance with the indicated grant of uplink resources and the indicated precoding associated with the coherency configuration.

Another UE for wireless communications is described. The UE may include means for transmitting, from the UE, one or more SRSs, means for receiving, at the UE based on the transmission of the one or more SRSs, one or more indications of a grant of uplink resources and a precoding associated with a coherency configuration between the transmission of the one or more SRSs and an uplink transmission, and means for transmitting, from the UE, the uplink transmission in accordance with the indicated grant of uplink resources and the indicated precoding associated with the coherency configuration.

A non-transitory computer-readable medium storing code for wireless communications is described. The code may include instructions executable by one or more processors to transmit, from the UE, one or more SRSs, receive, at the UE based on the transmission of the one or more SRSs, one or more indications of a grant of uplink resources and a precoding associated with a coherency configuration between the transmission of the one or more SRSs and an uplink transmission, and transmit, from the UE, the uplink transmission in accordance with the indicated grant of uplink resources and the indicated precoding associated with the coherency configuration.

In some examples of the method, UEs, and non-transitory computer-readable medium described herein, the coherency configuration may be associated with whether a relative phase coherency, a relative power coherency, or both may be maintained, between the transmission of the one or more SRSs and the uplink transmission, for a set of one or more antenna ports at the UE.

Some examples of the method, UEs, and non-transitory computer-readable medium described herein may further include operations, features, means, or instructions for transmitting, from the UE, an indication of a coherency duration, where the indicated precoding associated with the coherency configuration may be based on the indicated coherency duration.

In some examples of the method, UEs, and non-transitory computer-readable medium described herein, receiving the one or more indications may include operations, features, means, or instructions for receiving an indication of a precoding that may be associated with the UE maintaining coherency between the transmission of the one or more SRSs and the uplink transmission based on the uplink resources being within the indicated coherency duration from the transmission of the one or more SRSs.

Some examples of the method, UEs, and non-transitory computer-readable medium described herein may further include operations, features, means, or instructions for receiving the indication of the precoding that may be associated with the UE maintaining coherency between the transmission of the one or more SRSs and the uplink transmission may be further based on the uplink resources being within a bandwidth associated with the one or more SRSs.

In some examples of the method, UEs, and non-transitory computer-readable medium described herein, receiving the one or more indications may include operations, features, means, or instructions for receiving an indication of a precoding that may be not associated with the UE maintaining coherency between the transmission of the one or more SRSs and the uplink transmission based on the uplink resources being outside the indicated coherency duration from the transmission of the one or more SRSs.

In some examples of the method, UEs, and non-transitory computer-readable medium described herein, receiving the one or more indications may include operations, features, means, or instructions for transmitting, from the UE, an indication of a duration to perform radio frequency parameter updating at the UE, where receiving the one or more indications of the grant of uplink resources and the precoding associated with the coherency configuration may be based on the indicated duration to perform the radio frequency parameter update at the UE.

In some examples of the method, UEs, and non-transitory computer-readable medium described herein, the indication of the duration to perform radio frequency parameter updating at the UE may be transmitted within an indicated coherency duration from the transmission of the one or more SRSs based on the UE not maintaining coherency after the transmission of the one or more SRSs.

Some examples of the method, UEs, and non-transitory computer-readable medium described herein may further include operations, features, means, or instructions for receiving, at the UE, a coherency status reporting configuration, the coherency status reporting configuration indicating a first duration between a SRS transmission and a reporting occasion and a second duration between successive reporting occasions and transmitting, from the UE during a reporting occasion in accordance with the indicated first duration and second duration, an indication of whether the UE maintains coherency after transmission of the one or more SRSs, where receiving the one or more indications may be based on the transmission of the indication of whether the UE maintains coherency after transmission of the one or more SRSs.

In some examples of the method, UEs, and non-transitory computer-readable medium described herein, receiving the one or more indications may include operations, features, means, or instructions for receiving a first indication of a first precoding that may be associated with the UE maintaining coherency between the transmission of the one or more SRSs and the uplink transmission and receiving a second indication of a second precoding that may be not associated with the UE maintaining coherency between the transmission of the one or more SRSs and the uplink transmission.

Some examples of the method, UEs, and non-transitory computer-readable medium described herein may further include operations, features, means, or instructions for transmitting, from the UE, an indication of a capability of the UE to select a precoding based on coherency at the UE, where receiving the first indication of the first precoding and the second indication of the second precoding may be based on the indicated capability.

Some examples of the method, UEs, and non-transitory computer-readable medium described herein may further include operations, features, means, or instructions for selecting a precoding for the uplink transmission between the first precoding and the second precoding based on whether the UE may have maintained coherency since the transmission of the one or more SRSs and transmitting the uplink transmission in accordance with the selected precoding.

Some examples of the method, UEs, and non-transitory computer-readable medium described herein may further include operations, features, means, or instructions for transmitting an indication of the selected precoding with the uplink transmission.

In some examples of the method, UEs, and non-transitory computer-readable medium described herein, the first indication of the first precoding and the second indication of the second precoding may be both received in an instance of downlink control information (DCI).

In some examples of the method, UEs, and non-transitory computer-readable medium described herein, one of the first indication of the first precoding and the second indication of the second precoding may be received in an instance of DCI; and the other of the first indication of the first precoding and the second indication of the second precoding may be received in a medium access control (MAC) control element (CE).

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIGS. 1 and 2 show examples of wireless communications systems that support uplink precoding based on UE coherency in accordance with one or more aspects of the present disclosure.

FIG. 3 shows an example of signaling diagrams that supports uplink precoding based on UE coherency in accordance with one or more aspects of the present disclosure.

FIG. 4 shows an example of a process flow that supports uplink precoding based on UE coherency in accordance with one or more aspects of the present disclosure.

FIGS. 5 and 6 show block diagrams of devices that support uplink precoding based on UE coherency in accordance with one or more aspects of the present disclosure.

FIG. 7 shows a block diagram of a communications manager that supports uplink precoding based on UE coherency in accordance with one or more aspects of the present disclosure.

FIG. 8 shows a diagram of a system including a device that supports uplink precoding based on UE coherency in accordance with one or more aspects of the present disclosure.

FIG. 9 shows a flowchart illustrating a method that support uplink precoding based on UE coherency in accordance with one or more aspects of the present disclosure.

### DETAILED DESCRIPTION

In some wireless communication systems, a user equipment (UE) may support fully-coherent and non-coherent precoding for uplink codebooks. In some cases, a UE may indicate to a network entity whether the UE is capable of supporting fully-coherent precoding and the network entity may configure the UE with an uplink codebook based on the reported UE capabilities. In some examples, a UE may use a fully-coherent uplink codebook for uplink multiple-input multiple-output (MIMO) communications. For example, for uplink MIMO communications, UEs may be assumed to maintain coherency (e.g., maintain a relative phase coherency and a relative power coherency) across a set of antenna ports at the UE between a transmission of one or more sounding reference signals (SRSs) used for channel sounding and a transmission of an uplink transmission on a channel. However, a UE may be unable to maintain coherency indefinitely due to channel decorrelation in cases of a relatively large SRS periodicity and phase jumps due to UE radio frequency control updates. For example, switching between uplink and downlink modes or operations, power adaptations, antenna switching, and other operational transitions may result in radio frequency (RF) updates at the UE (e.g., at an RF transceiver of the UE), which may impair (e.g., prevent) an ability to maintain coherency. Moreover, while the UE may disable these control updates, such disabling that maintains coherency may result in other functionalities of the UE being negatively affected.

The techniques of the present disclosure describes a UE, a network entity, or both, tracking an UL MIMO coherency status of the UE and applying fully-coherent precoding when the UE is capable of maintaining coherency and non-coherent precoding otherwise. In some examples, the UE may indicate a coherency duration (e.g., a maximum coherency duration) that the UE is capable of maintaining after an SRS transmission and a network entity may configure the UE with a coherency duration and coherency parameters based on the indication. Further, in some cases, the network entity may configure the UE with an RF update time gap to provide the UE with time to adjust RF parameters when an SRS transmission period is less than the coherent duration. In some other cases, a UE-based or network-based event may trigger the UE to enter an RF update time gap before the end of a coherency duration. In another example, the UE may transmit a coherency status report to the network entity indicating whether the UE is still maintaining coherency. For example, the network entity may schedule the UE to maintain coherency for a duration (e.g., based on a duration capability from the UE, such as a maximum duration capability) and may schedule the UE with coherent precoding until a report is received indicating that the UE is unable to or has stopped maintaining the coherency. Additionally, or alternatively, the network entity may provide the UE with scheduling information for both coherent and non-coherent precoding and the UE may select which precoding to use based on a coherency status at the UE. Thus, the network entity may be capable of scheduling the UE with a resource allocation in accordance with a maintained coherency or potentially lost coherency based on the UE capabilities, which may improve the UL MIMO capabilities of the UE. Therefore, the techniques of the present disclosure may support the alignment of a precoding scheme with a coherency status of a UE to enhance the uplink MIMO communications within the wireless communications system, which may to increase the reliability and efficiency of the wireless communications system.

Aspects of the disclosure are initially described in the context of wireless communications systems. Additional aspects of the disclosure are described with reference to a wireless communications system, signaling diagrams, and a process flow. Aspects of the disclosure are further illustrated by and described with reference to apparatus diagrams, system diagrams, and flowcharts that relate to uplink precoding based on UE coherency.

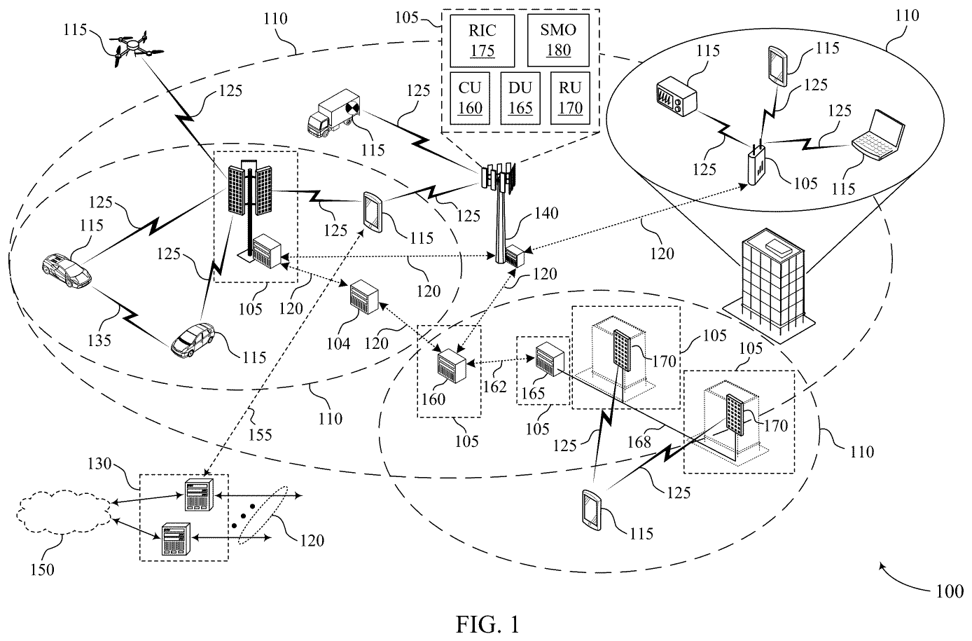

FIG. 1 shows an example of a wireless communications system 100 that supports uplink precoding based on UE coherency in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., an RF access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support uplink precoding based on UE coherency as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some examples of the wireless communications system 100, UEs 115 may support fully-coherent and non-coherent precoding for uplink codebooks. In some cases, a UE 115 may indicate to a network entity 105 whether the UE 115 is capable of supporting fully-coherent precoding and the network entity 105 may configure the UE 115 with an uplink codebook based on the reported capabilities of the UE 115. In some examples, a UE 115 may use a fully-coherent uplink codebook for uplink MIMO communication where UEs 115 may be assumed to maintain coherency (e.g., maintain a relative phase coherency and a relative power coherency) across a set of antenna ports at the UE 115. However, a UE 115 may be unable to maintain coherency indefinitely due to channel decorrelation in cases of a relatively large SRS periodicity and phase jumps due to UE 115 radio frequency control updates.

The techniques of the present disclosure support a UE 115, a network entity 105, or both, tracking an uplink MIMO coherency status of the UE 115 and applying fully-coherent precoding when the UE 115 is capable of maintaining coherency and non-coherent precoding otherwise. In some examples, the UE 115 may indicate a coherency duration (e.g., a maximum coherency duration) that the UE 115 is capable of maintaining after an SRS transmission and a network entity 105 may configure the UE 115 with a coherency duration and coherency parameters based on the indication. Further, in some cases, the network entity 105 may configure the UE 115 with an RF update time gap to provide the UE 115 with time to adjust RF parameters when an SRS transmission period is less than the coherent duration. In some other cases, an event at the UE 115 (e.g., a UE-based event) or at the network entity 105 (e.g., a network-based event) may trigger the UE 115 to enter an RF update time gap before the end of a coherency duration. In another example, the UE 115 may transmit a coherency status report to the network entity 105 indicating whether the UE 115 is still maintaining coherency. For example, the network entity 105 may schedule the UE 115 to maintain coherency for a duration (e.g., based on a duration capability, such as a maximum duration capability, from the UE 115) and may schedule the UE 115 with coherent precoding until a report is received indicating that the UE 115 is unable to or has stopped maintaining the coherency. Additionally, or alternatively, the network entity 105 may provide the UE 115 with scheduling information for both coherent and non-coherent precoding and the UE 115 may select which precoding to use based on a coherency status at the UE 115. Thus, the network entity 105 may be capable of scheduling the UE 115 with a resource allocation (e.g., with a precoding configuration) in accordance with a maintained coherency or potentially lost coherency based on the UE 115 capabilities to improve the uplink MIMO capabilities of the UE 115. Therefore, the techniques of the present disclosure may support the alignment of a precoding scheme with a coherency status of a UE 115 to enhance the uplink MIMO communications within the wireless communications system 100, which may to increase the reliability and efficiency of the wireless communications system 100.

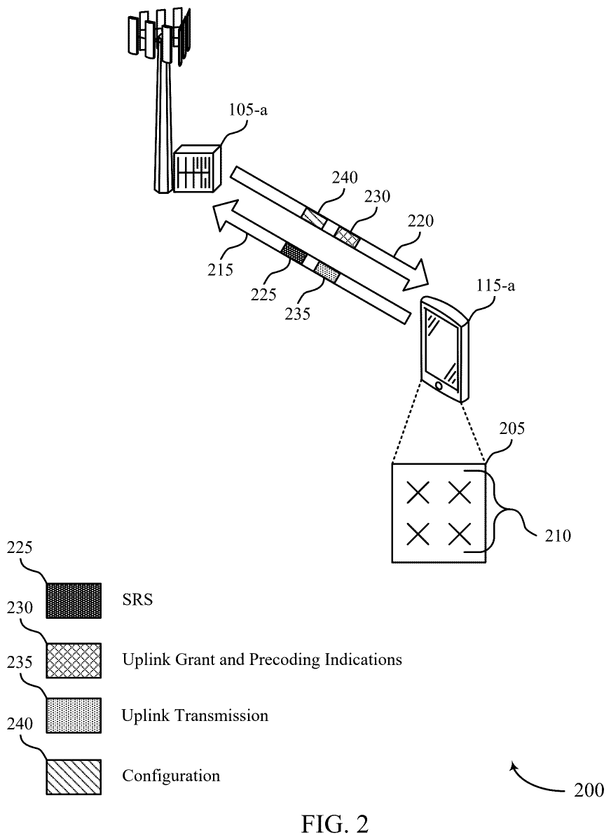

FIG. 2 shows an example of a wireless communications system 200 that supports uplink precoding based on UE coherency in accordance with one or more aspects of the present disclosure. The wireless communications system 200 may implement or be implemented by the wireless communications system 100. For example, the wireless communications system 200 may include a network entity 105-a and a UE 115-a, the UE 115-a configured with an antenna panel 205 that includes one or more antenna ports 210. The UE 115-a may communicate with the network entity 105-a via an uplink communication link 215 and the network entity 105-a may communicate with the UE 115-a via a downlink communication link 220. The uplink communication link 215 and the downlink communication link 220 may be or include examples of a Uu link, a sidelink, a D2D link or some other type of communication link 125.

The UE 115-a may support both fully-coherent and non-coherent precoding. Non-coherent precoding may correspond to an antenna port 210 selection that is based on an absence of coherent combining gain of signals that the UE 115-a transmits using different antenna ports 210 (e.g., a precoding that implements a single antenna port 210). Fully-coherent precoding may be an example of the UE 115-a attempting to maximize a coherent combining gain from signals that the UE 115-a transmits using different antenna ports 210 (e.g., a precoding that implements all of the antenna ports 210). In some cases, the UE 115-a may transmit a capability message (e.g., a UE capability message) to the network entity 105-a to indicate whether the UE 115-a is capable of supporting fully-coherent transmissions. Based on the capability message, the network entity 105-a may configure (e.g., schedule) the UE 115-a with fully-coherent or non-coherent precoding. Additionally, or alternatively, the network entity 105-a may configure the UE 115-a with partially-coherent precoding (e.g., a precoding that implements multiple antenna ports 210 but fewer than all of the antenna ports 210). As used herein, a coherent precoding may refer to a fully-coherent precoding or a partially-coherent precoding, either of which may be supported by a UE 115-a maintaining coherency after an SRS transmission.

In some cases, the UE 115-a may maintain coherency for uplink MIMO communications. Coherency for fully-coherent or partially-coherent transmissions may refer to the UE 115-a being capable of maintaining the same relative phase, relative power, or both, across the set of antenna ports 210 at the antenna panel 205 of the UE 115-a between a channel sounding time and an uplink transmission. In some examples, channel sounding may be based on the UE 115-a transmitting one or more SRSs 225 to the network entity 105-a via the uplink communication link 215. However, maintaining full coherency using fully-coherent precoding may be relatively challenging for the UE 115-a. For example, the UE 115-a may experience channel decorrelation if a SRS 225 transmission periodicity is relatively large thus making maintain coherency relatively challenging for the UE 115-a (e.g., as a result of RF updates that may disrupt coherency at the UE 115-a). In some cases, phase shift due to RF control parameter updates may also cause the UE 115-a to be unable to maintain coherency. For example, the UE 115-a may experience a phase shift when switching between uplink and downlink communications, switching power adaptations, switching antenna ports 210, and other updates to a configuration of an RF chain at the UE 115-a. In some examples, the UE 115-a may disable such updates to maintain phase coherency, power coherency, or both, however, disabling such updates may be complex and may impact the performance of the UE 115-a.

In some examples, the UE 115-a may implement (e.g., using a hardware component) a feature for fast returning to a reference phase and power state after an RF update event. However, such hardware implementation may increase the computational complexity at the UE 115-a to detect phase and power changes and to compensate for the changes. In another example, the UE 115-a may send one or more SRSs 225 to the network entity 105-a for calibration and the network entity 105-a may provide the UE 115-a with a set of calibration parameters based on measurements of the SRSs 225. However, measurements of the SRSs 225 may be relatively inaccurate in assisting in distinguishing fading effects and RF phase and power changes. Moreover, such over-the-air calibration may increase the latency of communications within the wireless communications system 100.

In accordance with examples as disclosed herein, to support relatively efficient and reliable uplink MIMO communications, the UE 115-a, the network entity 105-a, or both may keep track of an uplink MIMO coherency status at the UE 115-a. Utilizing the uplink MIMO coherency status, the network entity 105-a may be capable of configuring the UE 115-a with coherent precoding when the UE 115-a is capable of maintaining phase and power coherency and configuring the UE 115-a with non-coherent precoding otherwise. The techniques of the present disclosure may introduce one or more additional coherent MIMO schemes that restrict or limit RF updates at the UE 115-a, introduce UE 115 coherency reporting, introduce additional signaling from the network entity 105-a, or any combination thereof. Moreover, the techniques of the present disclosure may support that at least a portion of uplink transmission (e.g., physical uplink shared channel (PUSCH) occasions) are capable of having coherent signal combining gain without additional calibration efforts for the UE 115-a that increase the computational complexity or implementation complexity of the UE 115-a.

For example, in accordance with the techniques of the present disclosure, the UE 115-a may transmit one or more SRSs 225 (e.g., via resources of the uplink communication link 215). Based on the transmission of the one or more SRSs 225, the UE 115-a may receive, from the network entity 105-a (e.g., via the downlink communication link 220), uplink grant and precoding indications 230. In some examples, the uplink grant and precoding indications 230 may include one or more indications of a grant of uplink resources and a precoding associated with a coherency configuration between the transmission of the one or more SRS 225 and an uplink transmission 235. Further, based on receiving with the uplink grant and precoding indications 230, the UE 115-a may transmit, via the uplink communication link 215, the uplink transmission in accordance with the indicated grant of uplink resources and the indicated precoding associated with the coherency configuration. In some examples, the UE 115-a may also receive a configuration 240 from the network entity 105-a. In some cases, the configuration 240 may indicate the coherency configuration associated with the indicated precoding indicated via the uplink grant and precoding indications 230, a coherency status reporting configuration, information associated with radio frequency parameter updating durations, or any combination thereof.

In some cases, the uplink grant and precoding indications 230 may include information for both coherent precoding and non-coherent precoding. For example, the network entity 105-a may transmit an uplink grant (e.g., in accordance with one or more indications of downlink control information (DCI)) to the UE 115-a that indicates both a non-coherent transmission precoding matrix indicator (TPMI) with a corresponding modulation and coding scheme (MCS) and a coherent TPMI with a corresponding MCS. In some cases, the MCS associated with the coherent precoding may be associated with the MCS associated with the non-coherent precoding (e.g., the coherent precoding MCS may be a delta of the non-coherent precoding MCS). In another example, the UE 115-a may receive the coherent TPMI and MCS information in accordance with one or more indications of a MAC-control element (CE) and receive the non-coherent TPMI and MCS information in accordance with one or more indications of DCI, or vice versa. Based on receiving both the coherent and non-coherent precoding, the UE 115-a may determine whether to apply the coherent or non-coherent precoding at the UE 115-a based on a coherency status of the UE 115-a. In some examples, the UE 115-a may include an indication of such a determination (e.g., of a coherency status, of a selected precoding) with the uplink transmission 235. For example, the UE 115-a may encode the coherency information of the UE 115-a within control signals that are associated with (e.g., transmitted with) the uplink transmission 235. In some cases, the control signals may be prefixed to the beginning of the uplink transmission 235, embedded within the uplink transmission 235, or the control signals may be piggy-backed on the transmission of the uplink transmission 235. Thus, the network entity 105-a may be capable of detecting whether the UE 115-a has applied coherent precoding or non-coherent precoding to the uplink transmission 235 based on decoding the control signals associated with the uplink transmission 235. Moreover, the network entity 105-a may also detect the corresponding MCS associated with the precoding selected by the UE 115-a for the transmission of the uplink transmission 235.

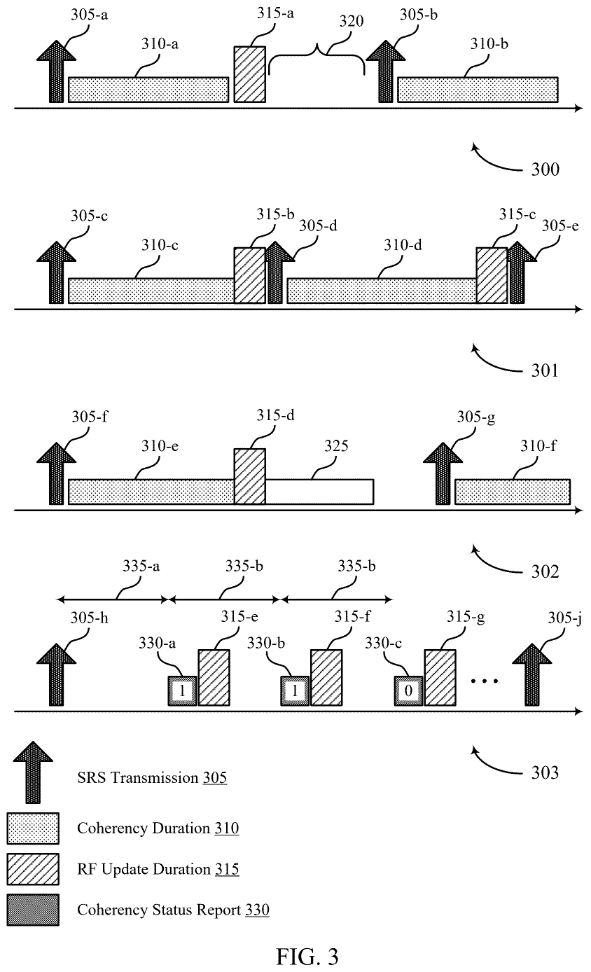

FIG. 3 shows an example of a signaling diagram 300, a signaling diagram 301, a signaling diagram 302, and a signaling diagram 303 that support uplink precoding based on UE coherency in accordance with one or more aspects of the present disclosure. The signaling diagrams 300, 301, 302, and 303 may implement or may be implemented by the wireless communications system 100, the wireless communications system 200, or both. For example, the signaling diagrams 300, 301, 302, and 303 may illustrate a signaling over a duration from a UE 115 to a network entity 105, which may be examples of devices or services described elsewhere herein including with reference to FIG. 1. Further, as illustrated herein, the UE 115 may perform one or more SRS transmissions 305 (e.g., an SRS transmission 305-a, an SRS transmission 305-b, an SRS transmission 305-c, an SRS transmission 305-d, an SRS transmission 305-e, an SRS transmission 305-f, an SRS transmission 305-g, an SRS transmission 305-h, and an SRS transmission 305-j) for uplink sounding as described herein (e.g., each in accordance with transmission of one or more SRSs 225).

A UE 115 may provide an indication of a coherency duration, such as a maximum coherency duration, during which the UE 115 can maintain coherency after an SRS transmission 305. In response, a network entity 105 may configure the UE 115 with a value (e.g., a coherent duration value) for a coherency duration 310 (e.g., a coherency duration 310-a, a coherency duration 310-b, a coherency duration 310-c, a coherency duration 310-d, a coherency duration 310-e, and a coherency duration 310-f). For example, as illustrated in the signaling diagram 300, if a corresponding uplink transmission (e.g., an uplink transmission 235) is scheduled to be transmitted within the coherency duration 310-a and a resource allocation (e.g., a frequency domain resource allocation) is included in a bandwidth of the previous SRSs (e.g., the SRSs of the SRS transmission 305-a) within the coherency duration 310-a, the network entity 105 may configure or schedule the UE 115 with coherent precoding during the coherency duration 310-a. Otherwise, if the uplink transmission is scheduled outside of the coherency duration 310-a or the resource allocation is not included in the bandwidth of the previous SRSs, the network entity 105 may configure or schedule the UE 115 with non-coherent precoding during the coherency duration 310-a.

Further, in some cases, a network entity 105, a UE 115, or both may configure an RF update duration 315 (e.g., an RF update duration 315-a, an RF update duration 315-b, an RF update duration 315-c, an RF update duration 315-d, an RF update duration 315-e, an RF update duration 315-f, and an RF update duration 315-g) to provide time for the UE 115 to adjust RF parameters (e.g., of an RF chain of the UE) when an SRS transmission 305 periodicity is less than the coherent duration. In some examples, the UE 115 may transmit an indication of a duration to perform RF parameter updating at the UE 115 and the network entity 105 may configure the UE 115 with the indicated duration. For example, an RF update duration 315-a may be applied after the coherency duration 310-a and before the SRS transmission 305-b. As illustrated in the example of signaling diagram 301, an RF update duration 315-b may be applied before (e.g., immediately before) the SRS transmission 305-d, and so on. In such cases, the UE 115 may apply non-coherent precoding during and/or after the RF update duration 315 (e.g., the RF update duration 315-a and the RF update duration 315-b). As such, if an uplink transmission (e.g., a PUSCH transmission, an uplink transmission 235) is scheduled during or after an RF update duration 315, non-coherent precoding may be scheduled for the uplink transmission.

In some examples, rather than having a UE 115 reapply a coherent precoding after an RF update duration 315, the network entity 105 may configure the UE 115 to apply non-coherent precoding until a next SRS transmission 305. For example, a UE 115 may apply non-coherent precoding during a duration 320 after the RF update duration 315-a and before the SRS transmission 305-b. After the SRS transmission 305-b, the UE 115 may reapply a coherent precoding during a coherency duration 310-b in accordance with the configured precoding from the network entity 105. In some examples, if an RF update duration 315-b is applied immediately before the SRS transmission 305-d, the UE 115 may apply the coherent precoding again after the SRS transmission 305-d.

Additionally, or alternatively, additional RF update durations 315 (e.g., an RF update duration 315-c) may occur before the end of a coherency duration 310 (e.g., a coherency duration 310-d). For example, in some cases, an event may trigger an RF update duration 315 to occur. In some examples, the event may be an update to one or more power control parameters, an antenna port switching, an uplink or downlink operation switch, or the event may be triggered by a UE 115. For example, the UE 115 may transmit a physical uplink control channel (PUCCH) message or a MAC-CE message indicating that the UE 115 is entering an RF update duration 315 (e.g., the RF update duration 315-c). As illustrated in the example of signaling diagram 302, after the RF update duration 315-d, which may be event-triggered, the UE 115 not maintain coherency during all of the coherency duration 310-e. For example, for a remainder duration 325 of the coherency duration 310-e (e.g., after the RF update duration 315-d), the UE 115 may be scheduled with non-coherent precoding until the coherency duration 310-f after the SRS transmission 305-g.

In some examples, as illustrated via the signaling diagram 303, a UE 115 may transmit a coherency status report 330 (e.g., a coherency status report 330-a, a coherency status report 330-b, and a coherency status report 330-c) in accordance with reporting periods 335 between consecutive SRS transmissions 305 (e.g., between successive coherency status reports 330 that are between the SRS transmission 305-h and the SRS transmission 305-j). In such examples, the UE 115 may transmit, to a network entity 105, an indication of a coherency duration 310, such as a maximum coherency duration, that the UE 115 can maintain coherency after an SRS transmission 305. Based on the indication of the UE 115 capability to maintain a relative phase coherency and a relative power coherency for at least the coherency duration, the network entity 105 may configure the UE 115 with one or more coherency reporting occasions after an SRS transmission 305 (e.g., the SRS transmission 305-h). For example, the network entity 105 may transmit, to the UE 115, a coherency status reporting configuration indicating and configuring the UE 115 with a first duration or gap between an SRS transmission 305 and a reporting occasion (e.g., the reporting period 335-a that is between the SRS transmission 305-h and the coherency status report 330-a) and a second duration between successive reporting occasions (e.g., the reporting period 335-b that is between the coherency status report 330-a and the coherency status report 330-b and that is between the coherency status report 330-b and the coherency status report 330-c), which may be equal to the first duration or different than the first duration. Moreover, the coherency status reporting configuration may configure the UE 115 to continue to transmit the coherency status reports 330 until a next SRS transmission 305 (e.g., until the SRS transmission 305-j). In some examples, the gaps (e.g., the first duration and second duration indicated via the coherency status reporting configuration) may be SRS resource-specific. For example, the UE 115 may apply different reporting sequences for different SRS resources. Additionally, or alternatively, the network entity 105 may transmit an indication for resources associated coherency status reporting configuration via an RRC message when the SRS transmissions 305 are periodic, via an RRC message, an activation command, or both when the SRS transmissions 305 are semi-persistent, or via an RRC message, a triggering DCI message, or both when the SRS transmissions 305 are aperiodic. Further, the network entity 105 may configure the UE 115 with an RF update duration 315 after each reporting occasion (e.g., after each occasion the UE 115 transmits a coherency status report 330) to provide the network entity 105 with a sufficient duration to decode the coherency status report 330.

The network entity 105 may schedule the UE 115 with coherent precoding or non-coherent precoding based on an indication of a coherency status report 330. For example, the network entity 105 may initially schedule the UE 115 with coherent precoding based on the indicated coherent duration (e.g., maximum coherent duration) that the UE 115 is capable of supporting, and the UE 115 may indicate a bit value of 1 via the coherency status report 330 to indicate that the UE 115 has maintained coherency. Further, if the UE 115 indicates a bit value of 0 via a coherency status report 330 (e.g., the coherency status report 330-c) the network entity 105 may schedule the UE 115 with non-coherent precoding. Therefore, an indication of a value of 1 within a coherency status report 330 may indicate that the UE 115 has maintained coherency and a value of 0 may indicate that the UE 115 has not maintained coherency, or vice versa.

The UE 115 may refrain from updating RF parameters during the RF update durations 315 until the UE 115 reports an indication of non-coherency via a coherency status report 330 (e.g., via the coherency status report 330-c). For example, the UE 115 may refrain from updating RF parameters during the RF update duration 315-e and the RF update duration 315-f and may wait until the RF update duration 315-g to update RF parameters based on the UE 115 indicating, via coherency status report 330-c, that the UE 115 has not been able to maintain coherency. Additionally, or alternatively, as the UE 115 may be configured with non-coherent precoding during an RF update duration 315, if an uplink transmission is scheduled during the RF update duration 315-e, the RF update duration 315-f, or the RF update duration 315-e, the UE 115 may apply non-coherent precoding to the uplink transmission.

Therefore, by utilizing the techniques of the present disclosure, a network entity 105 may be capable of scheduling a UE 115 with coherent precoding or non-coherent precoding based on the capabilities of the UE 115. Further, the addition of the RF update durations 315 may provide time for the UE 115 to update RF parameters between successive SRS transmissions 305 and support reliable communications.

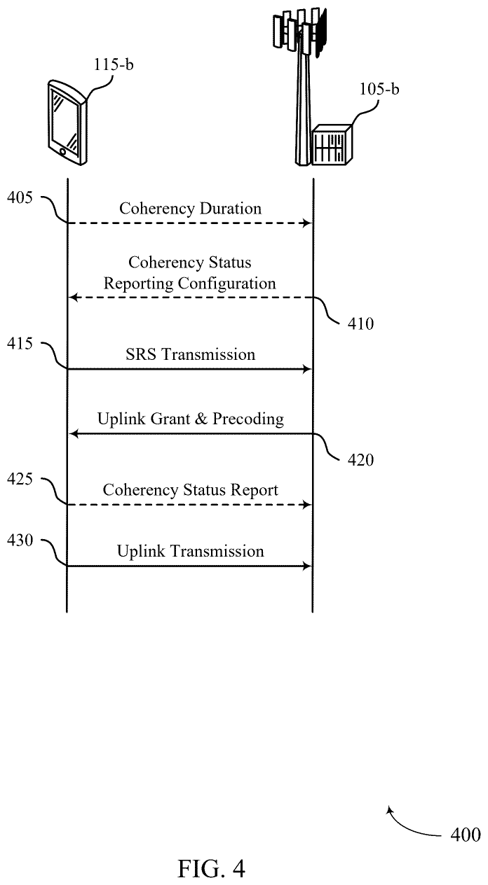

FIG. 4 shows an example of a process flow 400 that supports uplink precoding based on UE coherency in accordance with one or more aspects of the present disclosure. In some examples, the process flow 400 may implement or may be implemented by the wireless communications system 100, the wireless communications system 200, the signaling diagrams 300, the signaling diagram 301, the signaling diagram 302, the signaling diagram 303, or any combination thereof. The process flow 400 may refer to operations of a UE 115-b and a network entity 105-b.

In some examples, operations of the process flow 400 may be performed in different orders or at different times. Some operations may be omitted from the process flow 400, or other operations may be added. Although the process flow 400 may be described as being performed by the UE 115-b and the network entity 105-b, some aspects of some operations may also be performed by other devices, services, or models in accordance with the described techniques.

In some examples, at 405, the UE 115-b may transmit an indication of a coherency duration, which may be received by the network entity 105-b. In some cases, the coherency duration may indicate a duration (e.g., a maximum duration, a minimum duration, or a combination thereof) that the UE 115-b is capable of maintaining a relative phase coherency, a relative power coherency, or both between an SRS transmission and an uplink transmission (e.g., across a set of one or more antenna ports at the UE 115-b). In some cases, each antenna port of the UE 115-b may be capable of transmitting a single signal, and coherency may be between two or more antenna ports at the UE 115-b. In some other cases, each antenna port at the UE 115-b may be capable of transmitting multiple signals. Therefore, in some examples, coherency may be maintained per antenna port when the UE 115-b is capable of using each antenna port for multiple concurrent transmissions.

In some examples, at 410, the UE 115-b may receive (e.g., from the network entity 105-b) a coherency status reporting configuration. In some cases, the coherency status reporting configuration may indicate a first duration between an SRS transmission and a reporting occasion and a second duration between successive reporting occasions.

At 415, the UE 115-b may perform an SRS transmission (e.g., a transmission of one or more SRSs 225), which may be received by the network entity 105-b. For example, the UE 115-b may transmit the one or more SRSs to perform uplink sounding on a wireless communication channel or link.

At 420, the network entity 105-b may transmit (e.g., based on the SRS transmission of 415) one or more indications of a grant of uplink resources and a precoding associated with a coherency configuration between the SRS transmission of 415 and an uplink transmission, which may be received by the UE 115-b. In some examples, the coherency configuration may be associated with whether a relative phase coherency, a relative power coherency, or both are maintained, between the SRS transmission of 415 and the uplink transmission, for a set of one or more antenna ports at the UE 115-b. In some cases, the UE 115-b may receive, via the one or more indications of 420, an indication of a precoding that is associated with the UE 115-b maintaining coherency between the SRS transmission of 415 and the uplink transmission based on the uplink resources being within the indicated coherency duration from the SRS transmission of 415. Additionally, or alternatively, the UE 115-b may receive the indication of the precoding that is associated with the UE 115-b maintaining the coherency between the SRS transmission of 415 and the uplink transmission based on the uplink resources being within a bandwidth associated with the transmitted SRSs. In some other cases, the UE 115-b may receive, via the indication(s) of 420, an indication of a precoding that is not associated with the UE maintaining coherency between SRS transmission of 415 and the uplink transmission based on the uplink resources being outside the indicated coherency duration from SRS transmission of 415. Additionally, or alternatively, the UE 115-b may receive the indication(s) based on the transmitting the indication of whether the UE 115-b has maintained coherency since the SRS transmission of 415.

In some examples, the UE 115-b may transmit (e.g., to the network entity 105-b) an indication of a duration to perform RF parameter updating at the UE 115-b and the indication(s) of 420 may be based on the indicated duration to perform the RF parameter update at the UE 115-b. Additionally, or alternatively, the indication of the duration to perform RF parameter updating at the UE 115-b may be within an indicated coherency duration from the SRS transmission of 415 based on the UE 115-b not maintaining coherency after the SRS transmission of 415.

In another example, the UE 115-b may receive, via the indication(s) of 420, a first indication of a first precoding that is associated with the UE 115-b maintaining coherency between the SRS transmission of 415 and an uplink transmission and a second indication of a second precoding that is not associated with the UE 115-b maintaining coherency between the SRS transmission of 415 and an uplink transmission. In some cases, the UE 115-b may transmit (e.g., to the network entity 105-b) an indication of a capability of the UE 115-b to select a precoding based on coherency at the UE 115-b and the UE 115-b may receive the first indication of the first precoding and the second indication of the second precoding based on the indicated capability. Further, in such cases, the UE 115-b may select the precoding for an uplink transmission, between the first precoding and the second precoding, based on whether the UE 115-b has maintained coherency since the SRS transmission of 415. In some examples, the UE 115-b may receive both the first indication of the first precoding and the second indication of the second precoding via an instance of DCI. In some other examples, the UE 115-b may receive one of the first indication of the first precoding and the second indication of the second precoding via an instance of DCI and the other of the first indication of the first precoding and the second indication of the second precoding via a MAC-CE.

In some examples, at 425, the UE 115-b may transmit (e.g., to the network entity 105-b) during a reporting occasion in accordance with the first duration and the second duration indicated via the coherency status reporting configuration, an indication of whether the UE 115-b has maintained coherency after the SRS transmission of 415.

At 430, the UE 115-b may transmit the uplink transmission in accordance with the indicated grant of uplink resources and the indicated precoding associated with the coherency configuration, which may be received by the network entity 105-b. In some cases, the UE 115-b may transmit the uplink transmission in accordance with a selected precoding (e.g., as selected by the UE 115-b). In some examples, at 430, the UE 115-b may transmit an indication of the selected precoding with the uplink transmission.

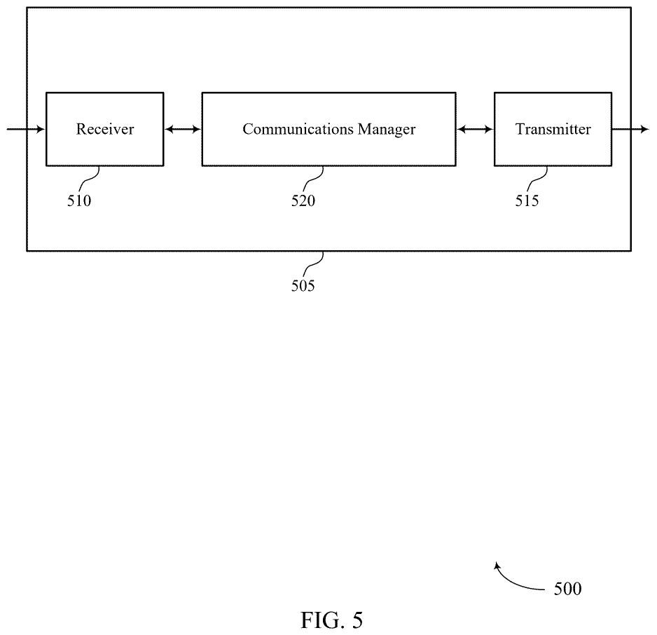

FIG. 5 shows a block diagram 500 of a device 505 that supports uplink precoding based on UE coherency in accordance with one or more aspects of the present disclosure. The device 505 may be an example of aspects of a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to, individually or collectively, support or enable the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to uplink precoding based on UE coherency). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to uplink precoding based on UE coherency). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations or components thereof may be examples of means for performing various aspects of uplink precoding based on UE coherency as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor (e.g., referred to as a processor-executable code). If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. For example, the communications manager 520 is capable of, configured to, or operable to support a means for transmitting (e.g., from the device 505) one or more sounding reference signals. The communications manager 520 is capable of, configured to, or operable to support a means for receiving (e.g., at the device 505) based on the transmission of the one or more sounding reference signals, one or more indications of a grant of uplink resources and a precoding associated with a coherency configuration between the transmission of the one or more sounding reference signals and an uplink transmission. The communications manager 520 is capable of, configured to, or operable to support a means for transmitting (e.g., from the device 505) the uplink transmission in accordance with the indicated grant of uplink resources and the indicated precoding associated with the coherency configuration.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for a network entity 105 to schedule a UE 115 with coherent or non-coherent precoding based on capabilities of the UE 115, which may support reduced processing, reduced power consumption, and more efficient utilization of communication resources.

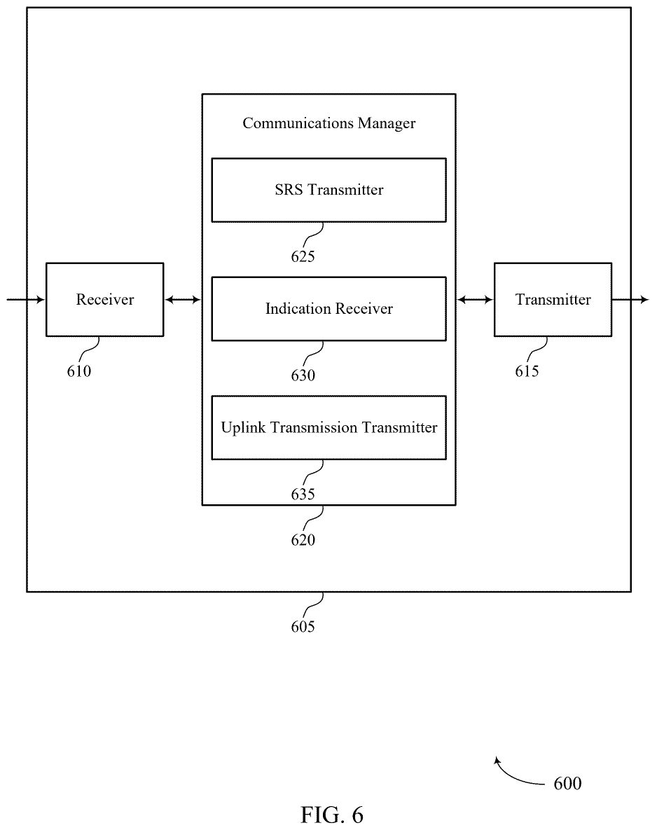

FIG. 6 shows a block diagram 600 of a device 605 that supports uplink precoding based on UE coherency in accordance with one or more aspects of the present disclosure. The device 605 may be an example of aspects of a device 505 or a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to support the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to uplink precoding based on UE coherency). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to uplink precoding based on UE coherency). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of uplink precoding based on UE coherency as described herein. For example, the communications manager 620 may include an SRS transmitter 625, an indication receiver 630, an uplink transmission transmitter 635, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. The SRS transmitter 625 is capable of, configured to, or operable to support a means for transmitting (e.g., from the device 605) one or more sounding reference signals. The indication receiver 630 is capable of, configured to, or operable to support a means for receiving (e.g., at the device 605) based on the transmission of the one or more sounding reference signals, one or more indications of a grant of uplink resources and a precoding associated with a coherency configuration between the transmission of the one or more sounding reference signals and an uplink transmission. The uplink transmission transmitter 635 is capable of, configured to, or operable to support a means for transmitting (e.g., from the device 605) the uplink transmission in accordance with the indicated grant of uplink resources and the indicated precoding associated with the coherency configuration.

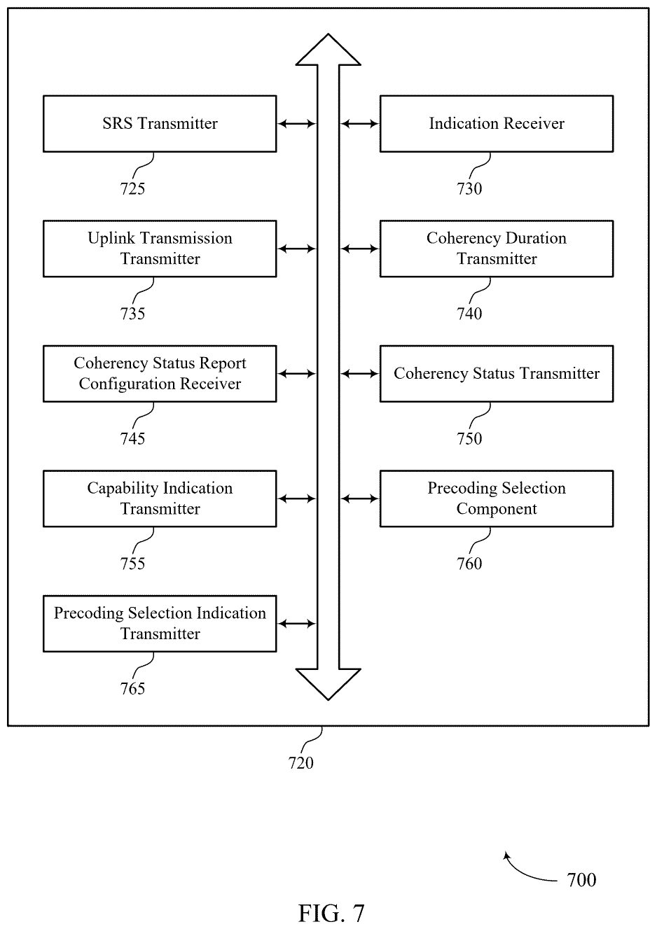

FIG. 7 shows a block diagram 700 of a communications manager 720 that supports uplink precoding based on UE coherency in accordance with one or more aspects of the present disclosure. The communications manager 720 may be an example of aspects of a communications manager 520, a communications manager 620, or both, as described herein. The communications manager 720, or various components thereof, may be an example of means for performing various aspects of uplink precoding based on UE coherency as described herein. For example, the communications manager 720 may include an SRS transmitter 725, an indication receiver 730, an uplink transmission transmitter 735, a coherency duration transmitter 740, a coherency status report configuration receiver 745, a coherency status transmitter 750, a capability indication transmitter 755, a precoding selection component 760, a precoding selection indication transmitter 765, or any combination thereof. Each of these components, or components or subcomponents thereof (e.g., one or more processors, one or more memories), may communicate, directly or indirectly, with one another (e.g., via one or more buses).

The communications manager 720 may support wireless communications in accordance with examples as disclosed herein. The SRS transmitter 725 is capable of, configured to, or operable to support a means for transmitting, from a UE, one or more sounding reference signals. The indication receiver 730 is capable of, configured to, or operable to support a means for receiving, at the UE based on the transmission of the one or more sounding reference signals, one or more indications of a grant of uplink resources and a precoding associated with a coherency configuration between the transmission of the one or more sounding reference signals and an uplink transmission. The uplink transmission transmitter 735 is capable of, configured to, or operable to support a means for transmitting, from the UE, the uplink transmission in accordance with the indicated grant of uplink resources and the indicated precoding associated with the coherency configuration.

In some examples, the coherency configuration is associated with whether a relative phase coherency, a relative power coherency, or both are maintained, between the transmission of the one or more sounding reference signals and the uplink transmission, for a set of one or more antenna ports at the UE.

In some examples, the coherency duration transmitter 740 is capable of, configured to, or operable to support a means for transmitting, from the UE, an indication of a coherency duration, where the indicated precoding associated with the coherency configuration is based on the indicated coherency duration.

In some examples, to support receiving the one or more indications, the indication receiver 730 is capable of, configured to, or operable to support a means for receiving an indication of a precoding that is associated with the UE maintaining coherency between the transmission of the one or more sounding reference signals and the uplink transmission based on the uplink resources being within the indicated coherency duration from the transmission of the one or more sounding reference signals.

In some examples, receiving the indication of the precoding that is associated with the UE maintaining coherency between the transmission of the one or more sounding reference signals and the uplink transmission is further based on the uplink resources being within a bandwidth associated with the one or more sounding reference signals.

In some examples, to support receiving the one or more indications, the indication receiver 730 is capable of, configured to, or operable to support a means for receiving an indication of a precoding that is not associated with the UE maintaining coherency between the transmission of the one or more sounding reference signals and the uplink transmission based on the uplink resources being outside the indicated coherency duration from the transmission of the one or more sounding reference signals.

In some examples, to support receiving the one or more indications, the indication receiver 730 is capable of, configured to, or operable to support a means for transmitting, from the UE, an indication of a duration to perform radio frequency parameter updating at the UE, where receiving the one or more indications of the grant of uplink resources and the precoding associated with the coherency configuration is based on the indicated duration to perform the radio frequency parameter update at the UE.

In some examples, the indication of the duration to perform radio frequency parameter updating at the UE is transmitted within an indicated coherency duration from the transmission of the one or more sounding reference signals based on the UE not maintaining coherency after the transmission of the one or more sounding reference signals.

In some examples, the coherency status report configuration receiver 745 is capable of, configured to, or operable to support a means for receiving, at the UE, a coherency status reporting configuration, the coherency status reporting configuration indicating a first duration between a sounding reference signal transmission and a reporting occasion and a second duration between successive reporting occasions. In some examples, the coherency status transmitter 750 is capable of, configured to, or operable to support a means for transmitting, from the UE during a reporting occasion in accordance with the indicated first duration and second duration, an indication of whether the UE maintains coherency after transmission of the one or more sounding reference signals, where receiving the one or more indications is based on the transmission of the indication of whether the UE maintains coherency after transmission of the one or more sounding reference signals.

In some examples, to support receiving the one or more indications, the indication receiver 730 is capable of, configured to, or operable to support a means for receiving a first indication of a first precoding that is associated with the UE maintaining coherency between the transmission of the one or more sounding reference signals and the uplink transmission. In some examples, to support receiving the one or more indications, the indication receiver 730 is capable of, configured to, or operable to support a means for receiving a second indication of a second precoding that is not associated with the UE maintaining coherency between the transmission of the one or more sounding reference signals and the uplink transmission.

In some examples, the capability indication transmitter 755 is capable of, configured to, or operable to support a means for transmitting, from the UE, an indication of a capability of the UE to select a precoding based on coherency at the UE, where receiving the first indication of the first precoding and the second indication of the second precoding is based on the indicated capability.

In some examples, the precoding selection component 760 is capable of, configured to, or operable to support a means for selecting a precoding for the uplink transmission between the first precoding and the second precoding based on whether the UE has maintained coherency since the transmission of the one or more sounding reference signals. In some examples, the uplink transmission transmitter 735 is capable of, configured to, or operable to support a means for transmitting the uplink transmission in accordance with the selected precoding.

In some examples, the precoding selection indication transmitter 765 is capable of, configured to, or operable to support a means for transmitting an indication of the selected precoding with the uplink transmission.

In some examples, the first indication of the first precoding and the second indication of the second precoding are both received in an instance of downlink control information.

In some examples, one of the first indication of the first precoding and the second indication of the second precoding is received in an instance of downlink control information; and the other of the first indication of the first precoding and the second indication of the second precoding is received in a medium access control MAC-CE.

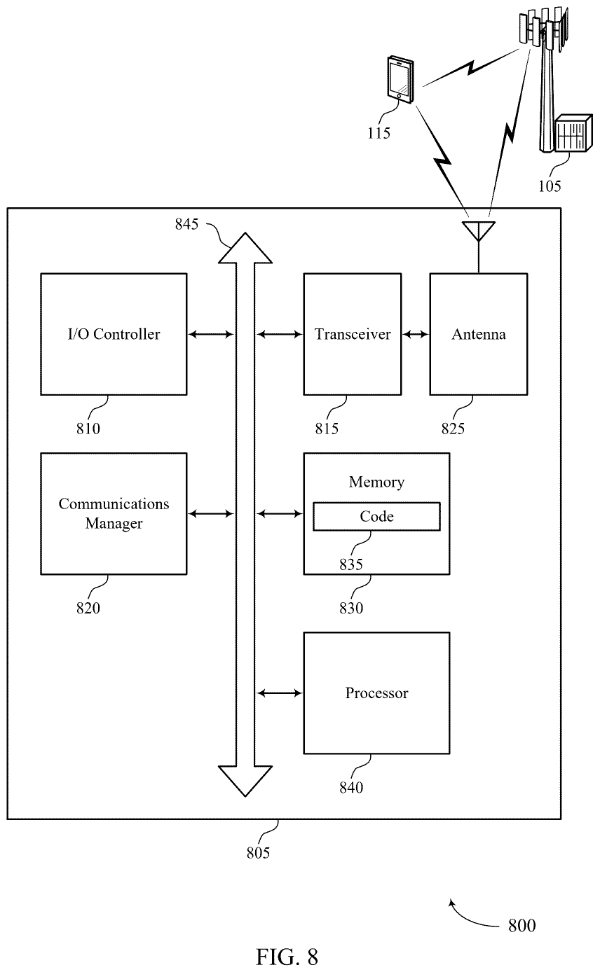

FIG. 8 shows a diagram of a system 800 including a device 805 that supports uplink precoding based on UE coherency in accordance with one or more aspects of the present disclosure. The device 805 may be an example of or include components of a device 505, a device 605, or a UE 115 as described herein. The device 805 may communicate (e.g., wirelessly) with one or more other devices (e.g., network entities 105, UEs 115, or a combination thereof). The device 805 may include components for bi-directional voice and data communications including components for transmitting and receiving communications, such as a communications manager 820, an input/output (I/O) controller, such as an I/O controller 810, a transceiver 815, one or more antennas 825, at least one memory 830, code 835, and at least one processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of one or more processors, such as the at least one processor 840. In some cases, a user may interact with the device 805 via the I/O controller 810 or via hardware components controlled by the I/O controller 810.

In some cases, the device 805 may include a single antenna. However, in some other cases, the device 805 may have more than one antenna, which may be capable of concurrently transmitting or receiving multiple wireless transmissions. The transceiver 815 may communicate bi-directionally via the one or more antennas 825 using wired or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The at least one memory 830 may include random access memory (RAM) and read-only memory (ROM). The at least one memory 830 may store computer-readable, computer-executable, or processor-executable code, such as the code 835. The code 835 may include instructions that, when executed by the at least one processor 840, cause the device 805 to perform various functions described herein. The code 835 may be stored in a non-transitory computer-readable medium such as system memory or another type of memory. In some cases, the code 835 may not be directly executable by the at least one processor 840 but may cause a computer (e.g., when compiled and executed) to perform functions described herein. In some cases, the at least one memory 830 may include, among other things, a basic I/O system (BIOS) which may control basic hardware or software operation such as the interaction with peripheral components or devices.

The at least one processor 840 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 840 may be configured to operate a memory array using a memory controller. In some other cases, a memory controller may be integrated into the at least one processor 840. The at least one processor 840 may be configured to execute computer-readable instructions stored in a memory (e.g., the at least one memory 830) to cause the device 805 to perform various functions (e.g., functions or tasks supporting uplink precoding based on UE coherency). For example, the device 805 or a component of the device 805 may include at least one processor 840 and at least one memory 830 coupled with or to the at least one processor 840, the at least one processor 840 and the at least one memory 830 configured to perform various functions described herein.

In some examples, the at least one processor 840 may include multiple processors and the at least one memory 830 may include multiple memories. One or more of the multiple processors may be coupled with one or more of the multiple memories, which may, individually or collectively, be configured to perform various functions described herein. In some examples, the at least one processor 840 may be a component of a processing system, which may refer to a system (such as a series) of machines, circuitry (including, for example, one or both of processor circuitry (which may include the at least one processor 840) and memory circuitry (which may include the at least one memory 830)), or components, that receives or obtains inputs and processes the inputs to produce, generate, or obtain a set of outputs. The processing system may be configured to perform one or more of the functions described herein. For example, the at least one processor 840 or a processing system including the at least one processor 840 may be configured to, configurable to, or operable to cause the device 805 to perform one or more of the functions described herein. Further, as described herein, being “configured to,” being “configurable to,” and being “operable to” may be used interchangeably and may be associated with a capability, when executing code 835 (e.g., processor-executable code) stored in the at least one memory 830 or otherwise, to perform one or more of the functions described herein.

The communications manager 820 may support wireless communications in accordance with examples as disclosed herein. For example, the communications manager 820 is capable of, configured to, or operable to support a means for transmitting (e.g., from the device 805) one or more sounding reference signals. The communications manager 820 is capable of, configured to, or operable to support a means for receiving (e.g., at the device 805) based on the transmission of the one or more sounding reference signals, one or more indications of a grant of uplink resources and a precoding associated with a coherency configuration between the transmission of the one or more sounding reference signals and an uplink transmission. The communications manager 820 is capable of, configured to, or operable to support a means for transmitting (e.g., from the device 805), the uplink transmission in accordance with the indicated grant of uplink resources and the indicated precoding associated with the coherency configuration.

By including or configuring the communications manager 820 in accordance with examples as described herein, the device 805 may support techniques for may support techniques for a network entity 105 to schedule the device 805 with coherent or non-coherent precoding based on capabilities of the device 805, which may support improved communication reliability, reduced latency, improved user experience related to reduced processing, reduced power consumption, more efficient utilization of communication resources, improved coordination between devices, longer battery life, and improved utilization of processing capability.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the at least one processor 840, the at least one memory 830, the code 835, or any combination thereof. For example, the code 835 may include instructions executable by the at least one processor 840 to cause the device 805 to perform various aspects of uplink precoding based on UE coherency as described herein, or the at least one processor 840 and the at least one memory 830 may be otherwise configured to, individually or collectively, perform or support such operations.

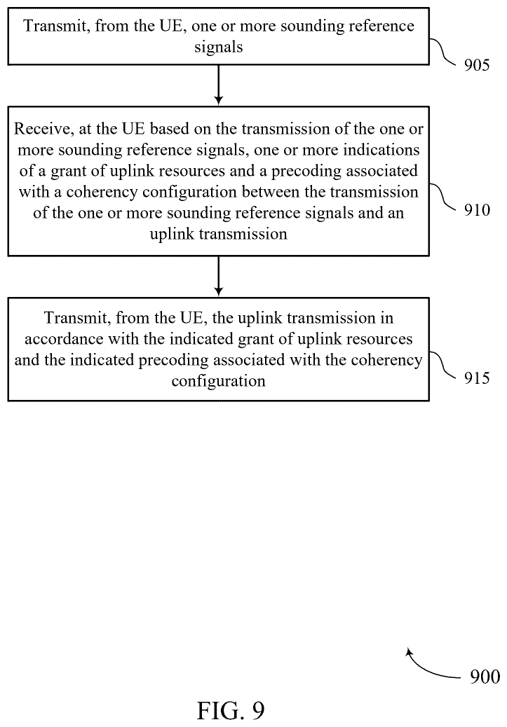

FIG. 9 shows a flowchart illustrating a method 900 that supports uplink precoding based on UE coherency in accordance with one or more aspects of the present disclosure. The operations of the method 900 may be implemented by a UE or its components as described herein. For example, the operations of the method 900 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 905, the method may include transmitting, from the UE, one or more sounding reference signals. The operations of 905 may be performed in accordance with examples as disclosed herein. In some examples, aspects of the operations of 905 may be performed by an SRS transmitter 725 as described with reference to FIG. 7.

At 910, the method may include receiving, at the UE based on the transmission of the one or more sounding reference signals, one or more indications of a grant of uplink resources and a precoding associated with a coherency configuration between the transmission of the one or more sounding reference signals and an uplink transmission. The operations of 910 may be performed in accordance with examples as disclosed herein. In some examples, aspects of the operations of 910 may be performed by an indication receiver 730 as described with reference to FIG. 7.

At 915, the method may include transmitting, from the UE, the uplink transmission in accordance with the indicated grant of uplink resources and the indicated precoding associated with the coherency configuration. The operations of 915 may be performed in accordance with examples as disclosed herein. In some examples, aspects of the operations of 915 may be performed by an uplink transmission transmitter 735 as described with reference to FIG. 7.

The following provides an overview of aspects of the present disclosure:

Aspect 1: A method for wireless communications by a UE, comprising: transmitting, from the UE, one or more SRSs; receiving, at the UE based at least in part on the transmission of the one or more SRSs, one or more indications of a grant of uplink resources and a precoding associated with a coherency configuration between the transmission of the one or more SRSs and an uplink transmission; and transmitting, from the UE, the uplink transmission in accordance with the indicated grant of uplink resources and the indicated precoding associated with the coherency configuration.

Aspect 2: The method of aspect 1, wherein the coherency configuration is associated with whether a relative phase coherency, a relative power coherency, or both are maintained, between the transmission of the one or more SRSs and the uplink transmission, for a set of one or more antenna ports at the UE.

Aspect 3: The method of any of aspects 1 through 2, further comprising: transmitting, from the UE, an indication of a coherency duration, wherein the indicated precoding associated with the coherency configuration is based at least in part on the indicated coherency duration.

Aspect 4: The method of aspect 3, wherein receiving the one or more indications comprises: receiving an indication of a precoding that is associated with the UE maintaining coherency between the transmission of the one or more SRSs and the uplink transmission based at least in part on the uplink resources being within the indicated coherency duration from the transmission of the one or more SRSs.

Aspect 5: The method of aspect 4, wherein receiving the indication of the precoding that is associated with the UE maintaining coherency between the transmission of the one or more SRSs and the uplink transmission is further based at least in part on the uplink resources being within a bandwidth associated with the one or more SRSs.

Aspect 6: The method of any of aspects 3 through 5, wherein receiving the one or more indications comprises: receiving an indication of a precoding that is not associated with the UE maintaining coherency between the transmission of the one or more SRSs and the uplink transmission based at least in part on the uplink resources being outside the indicated coherency duration from the transmission of the one or more SRSs.

Aspect 7: The method of any of aspects 1 through 6, wherein receiving the one or more indications comprises: transmitting, from the UE, an indication of a duration to perform radio frequency parameter updating at the UE, wherein receiving the one or more indications of the grant of uplink resources and the precoding associated with the coherency configuration is based at least in part on the indicated duration to perform the radio frequency parameter update at the UE.

Aspect 8: The method of aspect 7, wherein the indication of the duration to perform radio frequency parameter updating at the UE is transmitted within an indicated coherency duration from the transmission of the one or more SRSs based at least in part on the UE not maintaining coherency after the transmission of the one or more SRSs.

Aspect 9: The method of any of aspects 1 through 8, further comprising: receiving, at the UE, a coherency status reporting configuration, the coherency status reporting configuration indicating a first duration between a SRS transmission and a reporting occasion and a second duration between successive reporting occasions; and transmitting, from the UE during a reporting occasion in accordance with the indicated first duration and second duration, an indication of whether the UE maintains coherency after transmission of the one or more SRSs, wherein receiving the one or more indications is based at least in part on the transmission of the indication of whether the UE maintains coherency after transmission of the one or more SRSs.

Aspect 10: The method of any of aspects 1 through 9, wherein receiving the one or more indications comprises: receiving a first indication of a first precoding that is associated with the UE maintaining coherency between the transmission of the one or more SRSs and the uplink transmission; and receiving a second indication of a second precoding that is not associated with the UE maintaining coherency between the transmission of the one or more SRSs and the uplink transmission.

Aspect 11: The method of aspect 10, further comprising: transmitting, from the UE, an indication of a capability of the UE to select a precoding based at least in part on coherency at the UE, wherein receiving the first indication of the first precoding and the second indication of the second precoding is based at least in part on the indicated capability.

Aspect 12: The method of any of aspects 10 through 11, further comprising: selecting a precoding for the uplink transmission between the first precoding and the second precoding based at least in part on whether the UE has maintained coherency since the transmission of the one or more SRSs; and transmitting the uplink transmission in accordance with the selected precoding.

Aspect 13: The method of aspect 12, further comprising: transmitting an indication of the selected precoding with the uplink transmission.

Aspect 14: The method of any of aspects 10 through 13, wherein the first indication of the first precoding and the second indication of the second precoding are both received in an instance of DCI.

Aspect 15: The method of any of aspects 10 through 14, wherein one of the first indication of the first precoding and the second indication of the second precoding is received in an instance of DCI; and the other of the first indication of the first precoding and the second indication of the second precoding is received in a MAC-CE

Aspect 16: A UE for wireless communications, comprising one or more memories storing processor-executable code, and one or more processors coupled with the one or more memories and individually or collectively operable to execute the code to cause the UE to perform a method of any of aspects 1 through 15.

Aspect 17: A UE for wireless communications, comprising at least one means for performing a method of any of aspects 1 through 15.

Aspect 18: A non-transitory computer-readable medium storing code for wireless communications, the code comprising instructions executable by one or more processors to perform a method of any of aspects 1 through 15.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
transmit, from the UE, one or more sounding reference signals;
receive, at the UE based at least in part on the transmission of the one or more sounding reference signals, one or more indications of a grant of uplink resources and a precoding associated with a coherency configuration between the transmission of the one or more sounding reference signals and an uplink transmission; and
transmit, from the UE, the uplink transmission in accordance with the indicated grant of uplink resources and the indicated precoding associated with the coherency configuration.

2. The UE of claim 1, wherein the coherency configuration is associated with whether a relative phase coherency, a relative power coherency, or both are maintained, between the transmission of the one or more sounding reference signals and the uplink transmission, for a set of one or more antenna ports at the UE.

3. The UE of claim 1, wherein the one or more processors are individually or collectively further operable to execute the code to cause the UE to:
transmit, from the UE, an indication of a coherency duration, wherein the indicated precoding associated with the coherency configuration is based at least in part on the indicated coherency duration.

4. The UE of claim 3, wherein, to receive the one or more indications, the one or more processors are individually or collectively operable to execute the code to cause the UE to:
receive an indication of a precoding that is associated with the UE maintaining coherency between the transmission of the one or more sounding reference signals and the uplink transmission based at least in part on the uplink resources being within the indicated coherency duration from the transmission of the one or more sounding reference signals.

5. The UE of claim 4, wherein receiving the indication of the precoding that is associated with the UE maintaining coherency between the transmission of the one or more sounding reference signals and the uplink transmission is further based at least in part on the uplink resources being within a bandwidth associated with the one or more sounding reference signals.

6. The UE of claim 3, wherein, to receive the one or more indications, the one or more processors are individually or collectively operable to execute the code to cause the UE to:
receive an indication of a precoding that is not associated with the UE maintaining coherency between the transmission of the one or more sounding reference signals and the uplink transmission based at least in part on the uplink resources being outside the indicated coherency duration from the transmission of the one or more sounding reference signals.

7. The UE of claim 1, wherein, to receive the one or more indications, the one or more processors are individually or collectively operable to execute the code to cause the UE to:
transmit, from the UE, an indication of a duration to perform radio frequency parameter updating at the UE, wherein receiving the one or more indications of the grant of uplink resources and the precoding associated with the coherency configuration is based at least in part on the indicated duration to perform the radio frequency parameter update at the UE.

8. The UE of claim 7, wherein the indication of the duration to perform radio frequency parameter updating at the UE is transmitted within an indicated coherency duration from the transmission of the one or more sounding reference signals based at least in part on the UE not maintaining coherency after the transmission of the one or more sounding reference signals.

9. The UE of claim 1, wherein the one or more processors are individually or collectively further operable to execute the code to cause the UE to:
receive, at the UE, a coherency status reporting configuration, the coherency status reporting configuration indicating a first duration between a sounding reference signal transmission and a reporting occasion and a second duration between successive reporting occasions; and
transmit, from the UE during a reporting occasion in accordance with the indicated first duration and second duration, an indication of whether the UE maintains coherency after transmission of the one or more sounding reference signals, wherein receiving the one or more indications is based at least in part on the transmission of the indication of whether the UE maintains coherency after transmission of the one or more sounding reference signals.

10. The UE of claim 1, wherein, to receive the one or more indications, the one or more processors are individually or collectively operable to execute the code to cause the UE to:
receive a first indication of a first precoding that is associated with the UE maintaining coherency between the transmission of the one or more sounding reference signals and the uplink transmission; and
receive a second indication of a second precoding that is not associated with the UE maintaining coherency between the transmission of the one or more sounding reference signals and the uplink transmission.

11. The UE of claim 10, wherein the one or more processors are individually or collectively further operable to execute the code to cause the UE to:
transmit, from the UE, an indication of a capability of the UE to select a precoding based at least in part on coherency at the UE, wherein receiving the first indication of the first precoding and the second indication of the second precoding is based at least in part on the indicated capability.

12. The UE of claim 10, wherein the one or more processors are individually or collectively further operable to execute the code to cause the UE to:
select a precoding for the uplink transmission between the first precoding and the second precoding based at least in part on whether the UE has maintained coherency since the transmission of the one or more sounding reference signals; and
transmit the uplink transmission in accordance with the selected precoding.

13. The UE of claim 12, wherein the one or more processors are individually or collectively further operable to execute the code to cause the UE to:
transmit an indication of the selected precoding with the uplink transmission.

14. The UE of claim 10, wherein the first indication of the first precoding and the second indication of the second precoding are both received in an instance of downlink control information.

15. The UE of claim 10, wherein one of the first indication of the first precoding and the second indication of the second precoding is received in an instance of downlink control information; and the other of the first indication of the first precoding and the second indication of the second precoding is received in a medium access control (MAC) control element (CE).

16. A method for wireless communications by a user equipment (UE), comprising:
transmitting, from the UE, one or more sounding reference signals;
receiving, at the UE based at least in part on the transmission of the one or more sounding reference signals, one or more indications of a grant of uplink resources and a precoding associated with a coherency configuration between the transmission of the one or more sounding reference signals and an uplink transmission; and
transmitting, from the UE, the uplink transmission in accordance with the indicated grant of uplink resources and the indicated precoding associated with the coherency configuration.

17. The method of claim 16, wherein the coherency configuration is associated with whether a relative phase coherency, a relative power coherency, or both are maintained, between the transmission of the one or more sounding reference signals and the uplink transmission, for a set of one or more antenna ports at the UE.

18. The method of claim 16, further comprising:
transmitting, from the UE, an indication of a coherency duration, wherein the indicated precoding associated with the coherency configuration is based at least in part on the indicated coherency duration.

19. The method of claim 16, further comprising:
receiving, at the UE, a coherency status reporting configuration, the coherency status reporting configuration indicating a first duration between a sounding reference signal transmission and a reporting occasion and a second duration between successive reporting occasions; and
transmitting, from the UE during a reporting occasion in accordance with the indicated first duration and second duration, an indication of whether the UE maintains coherency after transmission of the one or more sounding reference signals, wherein receiving the one or more indications is based at least in part on the transmission of the indication of whether the UE maintains coherency after transmission of the one or more sounding reference signals.

20. A non-transitory computer-readable medium storing code for wireless communications, the code comprising instructions executable by one or more processors to:
transmit, from a user equipment (UE), one or more sounding reference signals;
receive, at the UE based at least in part on the transmission of the one or more sounding reference signals, one or more indications of a grant of uplink resources and a precoding associated with a coherency configuration between the transmission of the one or more sounding reference signals and an uplink transmission; and
transmit, from the UE, the uplink transmission in accordance with the indicated grant of uplink resources and the indicated precoding associated with the coherency configuration.
